(19) United States
(12) Patent Application Publication
(10) Pub. No.: US 2026/0056502 A1
(43) Pub. Date: Feb. 26, 2026

(54) IMAGE FORMING SYSTEM, NON-TRANSITORY COMPUTER READABLE MEDIUM STORING PROGRAM, AND IMAGE FORMING METHOD

(71) Applicant: FUJIFILM Business Innovation Corp., Tokyo (JP)

(72) Inventors: Chihiro MATSUGUMA, Kanagawa (JP); Yuichi NISHIKUNI, Kanagawa (JP); Tatsuya NAMIKI, Kanagawa (JP); Mitsunori SHIOI, Kanagawa (JP)

(73) Assignee: FUJIFILM Business Innovation Corp., Tokyo (JP)

(21) Appl. No.: 19/047,662

(22) Filed: Feb. 7, 2025

(30) Foreign Application Priority Data
Aug. 23, 2024 (JP) 2024-143363

(51) Int. Cl. G03G 15/00; G03G 15/01; G03G 15/36

(52) U.S. Cl. CPC G03G 15/6561; G03G 15/0189; G03G 15/36

(57) ABSTRACT

An image forming system includes a first image forming unit including plural first image forming portions and a first intermediate transfer medium to which a toner image formed by the plural first image forming portions is primarily transferred, a second image forming unit that is provided on a downstream side of a sheet transport direction with respect to the first image forming unit and that includes plural second image forming portions and a second intermediate transfer medium to which a toner image formed by the plural second image forming portions is primarily transferred, a sheet transport portion that transports a sheet to a secondary transfer position at which each of the toner image formed on the first intermediate transfer medium of the first image forming unit and the toner image formed on the second intermediate transfer medium of the second image forming unit is secondarily transferred, and a processor configured to, in performing registration between a position of an image printed on the sheet by the first image forming unit and a position of an image printed on the sheet by the second image forming unit, cause each of one first image forming portion selected from the plural first image forming portions of the first image forming unit and one second image forming portion selected from the plural second image forming portions of the second image forming unit to form the image at the same position on the sheet, and reduce a misregistration amount by partially changing a drawing cycle of the image in any one of the first image forming unit or the second image forming unit in accordance with a relative misregistration amount between the two formed images.

### CROSS-REFERENCE TO RELATED APPLICATIONS

This application is based on and claims priority under 35 USC 119 from Japanese Patent Application No. 2024-143363 filed Aug. 23, 2024.

### BACKGROUND

### (i) Technical Field

The present disclosure relates to an image forming system, a non-transitory computer readable medium storing a program, and an image forming method.

### (ii) Related Art

JP2005-274919A discloses an image forming apparatus capable of forming an image having image quality high enough to substitute for a printer by correcting a misregistration correction amount for positions in a main scanning direction and a sub-scanning direction, a leading edge skew, a side edge skew, and the like even in a case where there is error in an attachment position of a detection section that detects a misregistration detection pattern.

JP2018-101093A discloses an image forming apparatus including a selection section that selects a reference edge of a sheet, a generation section that generates an adjustment condition for adjusting a printing position on the sheet based on a reading result of a scanner unit and on the selected reference edge, and a CPU that performs image processing on image data based on the generated adjustment condition and that causes an exposure device and the like to form an image based on the image data subjected to the image processing.

### SUMMARY OF THE INVENTION

In recent years, in order to extend a color gamut of an image formed by an image forming apparatus, the image has been formed using not only toner of basic colors such as CMYK colors but also toner of special colors other than CMYK. Such an image forming apparatus may use a configuration of forming toner images on a sheet using two image forming units each including a plurality of image forming portions that form the toner images. Each image forming unit primarily transfers the toner image formed by the plurality of image forming portions onto an intermediate transfer medium and secondarily transfers the toner image on the intermediate transfer medium onto the sheet transported along a sheet transport path. That is, in forming the toner images on the sheet using two image forming units, the secondary transfer is performed at two secondary transfer positions. Thus, the sheet fed from a sheet feed tray passes through the two secondary transfer positions via sheet feed rolls and resist rolls.

However, in a case where a sheet rear end passes through the sheet feed rolls or the resist rolls in forming the images on the sheet using such a configuration, a sheet transport speed may partially change while the images are being formed on one sheet. In a case where the sheet transport speed partially changes, partial misregistration occurs between the respective images formed by two image forming units on one sheet.

Aspects of non-limiting embodiments of the present disclosure relate to an image forming system, a non-transitory computer readable medium storing a program, and an image forming method that capable of suppressing partial misregistration between respective images formed by two image forming units on one sheet.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming system including a first image forming unit including a plurality of first image forming portions and a first intermediate transfer medium to which a toner image formed by the plurality of first image forming portions is primarily transferred, a second image forming unit that is provided on a downstream side of a sheet transport direction with respect to the first image forming unit and that includes a plurality of second image forming portions and a second intermediate transfer medium to which a toner image formed by the plurality of second image forming portions is primarily transferred, a sheet transport portion that transports a sheet to a secondary transfer position at which each of the toner image formed on the first intermediate transfer medium of the first image forming unit and the toner image formed on the second intermediate transfer medium of the second image forming unit is secondarily transferred, and a processor configured to, in performing registration between a position of an image printed on the sheet by the first image forming unit and a position of an image printed on the sheet by the second image forming unit, cause each of one first image forming portion selected from the plurality of first image forming portions of the first image forming unit and one second image forming portion selected from the plurality of second image forming portions of the second image forming unit to form the image at the same position on the sheet, and reduce a misregistration amount by partially changing a drawing cycle of the image in any one of the first image forming unit or the second image forming unit in accordance with a relative misregistration amount between the two formed images.

### BRIEF DESCRIPTION OF THE DRAWINGS

Exemplary embodiment(s) of the present invention will be described in detail based on the following figures, wherein:

FIG. 1 is a diagram illustrating a configuration of an image forming apparatus 10 according to one exemplary embodiment of the present disclosure;

FIG. 2 is a diagram for describing configurations of image forming portions 32P, 32S, 32G, and 32Gr and configurations of image forming portions 52Y, 52M, 52C, and 52K;

FIG. 3 is a diagram for describing a configuration of a control device 80 that controls an operation of the image forming apparatus 10;

FIG. 4 is a diagram illustrating a state (speed variation point 1) immediately after a rear end of a sheet PP passes through sheet feed rolls 14;

FIG. 5 is a diagram illustrating a state (speed variation point 2) immediately after the rear end of the sheet PP passes through resist rolls 15;

FIG. 6 is a flowchart for describing an overall operation in performing misregistration correction between two image forming units 30 and 50;

FIG. 7 is a diagram illustrating an example of a reference sheet on which a plurality of reference lines orthogonal to a transport direction of the sheet are printed at intervals of 20 mm in advance;

FIG. 8 is a diagram illustrating an example of an adjustment chart generated by printing straight lines at intervals of 20 mm using a color K and a color Gr in accordance with positions of the reference lines on the reference sheet;

FIG. 9 is a diagram illustrating a detection example in a case where a speed change point of a sheet transport speed is detected from the adjustment chart illustrated in FIG. 8;

FIG. 10 is a diagram illustrating an example of the adjustment chart generated by printing straight lines at intervals of 20 mm using the color K and the color Gr on a general printing sheet;

FIG. 11 is a diagram illustrating a detection example in a case where the speed change point of the sheet transport speed is detected from the adjustment chart illustrated in FIG. 10;

FIG. 12 is a diagram illustrating a state of a printed image in a case where the misregistration correction is performed based on an absolute position using the reference sheet; and

FIG. 13 is a diagram illustrating a state of the printed image in a case where the misregistration correction is performed based on a relative position.

### DETAILED DESCRIPTION OF THE INVENTION

Next, an exemplary embodiment of the present disclosure will be described in detail with reference to the drawings.

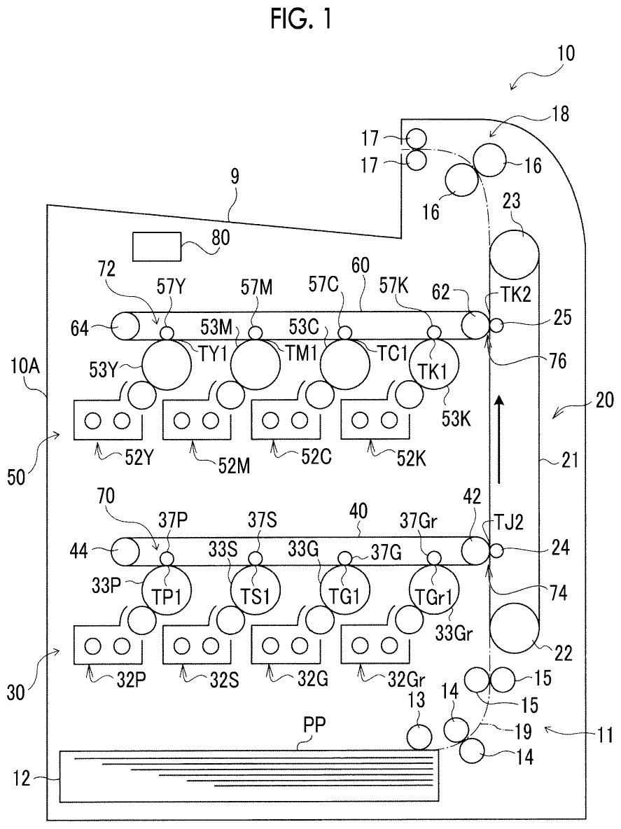

FIG. 1 is a diagram illustrating a configuration of an image forming apparatus 10 according to one exemplary embodiment of the present disclosure.

As illustrated in FIG. 1, the image forming apparatus 10 includes a sheet storage portion 12 accommodating a sheet PP, a transport portion 11 that transports the sheet PP along a transport path 19, an image forming unit 30 and an image forming unit 50 that form a toner image to be transferred to the sheet PP, and a control device 80.

The sheet storage portion 12 can be pulled out from an image forming apparatus body 10A that is an apparatus body of the image forming apparatus 10, and accommodates the sheet PP.

The transport portion 11 includes, in order from an upstream side of a transport direction, a feed roll 13, sheet feed rolls 14, resist rolls 15, a transport device 20, a fixing portion 18, discharge rolls 17, and the like and functions as a sheet transport portion.

The feed roll 13 feeds the sheet PP stored in the sheet storage portion 12 to the transport path 19 constituting the transport portion 11. The sheet feed rolls 14 feed the sheet PP stored in the sheet storage portion 12 to the resist rolls 15 along the transport path 19.

The resist rolls 15 transport the sheet PP fed by the sheet feed rolls 14 to a secondary transfer position TJ2, described later, at an increased transport speed. The resist rolls 15 transport the sheet PP to a downstream side of the transport direction with the sheet PP sandwiched between the resist rolls 15. The resist rolls 15 are sheet position adjustment rolls that transport the sheet PP fed from the sheet storage portion 12 at a predetermined timing to the secondary transfer position TJ2 at which a secondary transfer portion 74 performs secondary transfer.

The transport device 20 transports the sheet PP to the downstream side of the transport direction along the transport path 19 while transferring toner images formed by the image forming units 30 and 50 to the sheet PP. Details of the transport device 20 will be described later.

The fixing portion 18 includes two fixing rolls 16 and fixes the toner images to the sheet PP by heating and pressing the sheet PP to which the toner images are transferred, while the sheet PP passes between the two fixing rolls 16. A position at which the toner images are fixed to the sheet PP by the two fixing rolls 16 will be referred to as a fixing position.

The discharge rolls 17 discharge the sheet PP to which the toner images are fixed by the fixing portion 18 to a discharge portion 9.

The image forming unit 30 and the image forming unit 50 are disposed next to each other in an up-down direction. In the present exemplary embodiment, the image forming unit 50 is disposed above the image forming unit 30. From another point of view, the image forming unit 50 is disposed on a downstream side of a sheet transport direction of the image forming unit 30.

The image forming unit 50 forms toner images of basic colors including yellow (Y), magenta (M), cyan (C), and black (K).

The image forming unit 30 forms toner image of special colors other than the basic colors. The image forming unit 30 includes four image forming portions 32 and an endless intermediate transfer belt 40 that is an intermediate transfer medium. Toner images formed by the four image forming portions 32 are transferred to the intermediate transfer belt 40 that is mounted to be rotatable counterclockwise in a front view of FIG. 1.

The image forming portions 32 include an image forming portion 32P that forms a toner image of a fluorescent pink color (P), an image forming portion 32S that forms a toner image of a silver color(S), an image forming portion 32G that forms a toner image of a gold color (G), and an image forming portion 32Gr that forms a toner image of a fluorescent green color (Gr). The four image forming portions 32 are disposed in an order of the image forming portion 32P, the image forming portion 32S, the image forming portion 32G, and the image forming portion 32Gr in order from an upstream side of a rotation direction (a side closer to a support roll 44, described later) in which the intermediate transfer belt 40 rotates. The image forming portions 32P, 32S, 32G, and 32Gr include photoconductors 33P, 33S, 33G, and 33Gr, respectively.

P, S, G, and Gr May Be Omitted Unless Distinction Therebetween Is Necessary.

Primary transfer rolls 37P, 37S, 37G, and 37Gr that transfer the toner images formed by the image forming portions 32 to the intermediate transfer belt 40 are disposed at respective positions facing the photoconductors 33 with the intermediate transfer belt 40 sandwiched therebetween. The intermediate transfer belt 40 is wound around the support roll 44 that supports the intermediate transfer belt 40, and a backup roll 42 disposed in a secondary transfer portion 74, described later, on the upstream side. A primary transfer portion 70 is configured to include the photoconductors 33, the primary transfer rolls 37, and the intermediate transfer belt 40. Primary transfer positions TP1, TS1, TG1, and TGr1 are defined between each of the photoconductors 33P, 33S, 33G, and 33Gr and the intermediate transfer belt 40.

The image forming unit 50 has the same configuration as the image forming unit 30 with only difference being colors used to form the images.

The image forming unit 50 includes four image forming portions 52 and an intermediate transfer belt 60 that is an intermediate transfer medium. Toner images formed by the four image forming portions 52 are transferred to the intermediate transfer belt 60 that is mounted to be rotatable counterclockwise in the front view of FIG. 1.

The image forming portions 52 have the same configuration as the image forming portions 32 of the image forming unit 30 with only difference being colors used to form the images. The intermediate transfer belt 60 and primary transfer rolls 57, described later, also have the same configurations as the intermediate transfer belt 40 and the primary transfer rolls 37 of the image forming unit 30. Other constituent members constituting the image forming unit 50 are also the same as the constituent members of the image forming unit 30.

The image forming portions 52 include an image forming portion 52Y that forms a toner image of a yellow color, an image forming portion 52M that forms a toner image of a magenta color, an image forming portion 52C that forms a toner image of a cyan color, and an image forming portion 52K that forms a toner image of a black color. The four image forming portions 52 are disposed in an order of the image forming portion 52Y, the image forming portion 52M, the image forming portion 52C, and the image forming portion 52K in order from the upstream side of the rotation direction (a side closer to a support roll 64, described later). That is, in the image forming portions 52, the image forming portion 52K is disposed on the most downstream side of the rotation direction. The image forming portions 52Y, 52M, 52C, and 52K include photoconductors 53Y, 53M, 53C, and 53K, respectively.

Y, M, C, and K may be omitted unless distinction therebetween is necessary.

Primary transfer rolls 57Y, 57M, 57C, and 57K are disposed at respective positions facing the photoconductors 53 with the intermediate transfer belt 60 sandwiched therebetween. The intermediate transfer belt 60 is wound around the support roll 64 and a backup roll 62 disposed in a secondary transfer portion 76, described later, on the downstream side. A primary transfer portion 72 is configured to include the photoconductors 53, the primary transfer rolls 57, and the intermediate transfer belt 60. Primary transfer positions TY1, TM1, TC1, and TK1 are defined between each of the photoconductors 53Y, 53M, 53C, and 53K and the intermediate transfer belt 60.

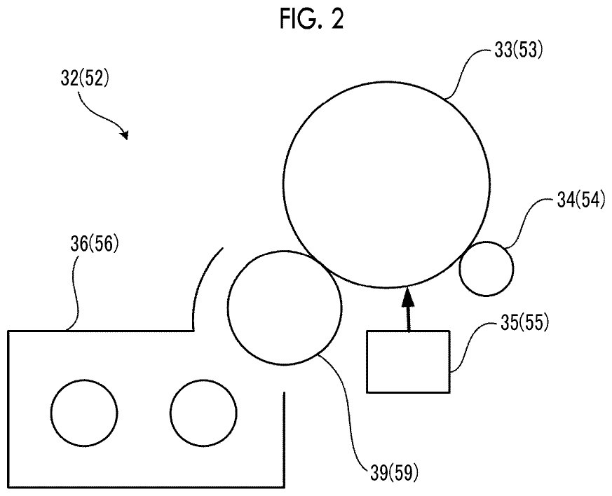

Next, configurations of the image forming portions 32P, 32S, 32G, and 32Gr will be described with reference to FIG. 2. Configurations of the image forming portions 52Y, 52M, 52C, and 52K in the image forming unit 50 will also be described together.

As illustrated in FIG. 2, each image forming portion 32 includes the photoconductor 33, a charging member 34 that charges a surface of the photoconductor 33, an exposure device 35 that irradiates the charged photoconductor 33 with exposure light, and a developing device 36 that visualizes a toner image by developing an electrostatic latent image formed by the irradiation with the exposure light. The developing device 36 includes a developing roll 39 to which a developing bias is applied.

Similarly, as illustrated in FIG. 2, each image forming portion 52 includes the photoconductor 53, a charging member 54, an exposure device 55, and a developing device 56. The developing device 56 includes a developing roll 59 to which a developing bias is applied.

Next, details of the transport device 20 will be described.

As illustrated in FIG. 1, the transport device 20 includes an endless transport belt 21, support rolls 22 and 23 that support the transport belt 21, and secondary transfer rolls 24 and 25 disposed at positions facing the backup rolls 42 and 62 with the intermediate transfer belts 40 and 60 sandwiched therebetween.

The secondary transfer roll 24 transfers the toner images formed on the intermediate transfer belt 40 of the image forming unit 30 to the sheet PP with the sheet PP and the transport belt 21 sandwiched between the secondary transfer roll 24 and the backup roll 42. Similarly, the secondary transfer roll 25 transfers the toner images formed on the intermediate transfer belt 60 of the image forming unit 50 to the sheet PP with the sheet PP and the transport belt 21 sandwiched between the secondary transfer roll 25 and the backup roll 62.

The secondary transfer portion 74 is configured to include the backup roll 42, the secondary transfer roll 24, and the intermediate transfer belt 40. The secondary transfer portion 76 is configured to include the backup roll 62, the secondary transfer roll 25, and the intermediate transfer belt 60.

A transfer bias is applied to each of the secondary transfer rolls 24 and 25.

The secondary transfer position TJ2 is defined between the intermediate transfer belt 40 of the image forming unit 30 and the transport belt 21, and a secondary transfer position TK2 is defined between the intermediate transfer belt 60 of the image forming unit 50 and the transport belt 21. The secondary transfer position TK2 is the most downstream secondary transfer position.

As described above, the image forming unit 30 includes four image forming portions 32P, 32S, 32G, and 32Gr and the intermediate transfer belt 40 to which the toner images formed by the four image forming portions 32 are primarily transferred. The image forming unit 50 is provided on the downstream side of the sheet transport direction with respect to the image forming unit 30. The image forming unit 50 includes four image forming portions 52Y, 52M, 52C, and 52K and the intermediate transfer belt 60 to which the toner images formed by the four image forming portions 52 are primarily transferred. The secondary transfer portion 74 is provided in accordance with the image forming unit 30 and secondarily transfers the toner images formed on the intermediate transfer belt 40 onto the sheet PP transported along the transport path 19. The secondary transfer portion 76 is provided in accordance with the image forming unit 50 and secondarily transfers the toner images formed on the intermediate transfer belt 60 onto the sheet PP transported along the transport path 19.

With the above configuration, the transport portion 11 transports the sheet PP to the secondary transfer positions TJ2 and TK2 at which the toner images formed on the intermediate transfer belt 40 of the image forming unit 30 and the toner images formed on the intermediate transfer belt 60 of the image forming unit 50 are secondarily transferred, respectively.

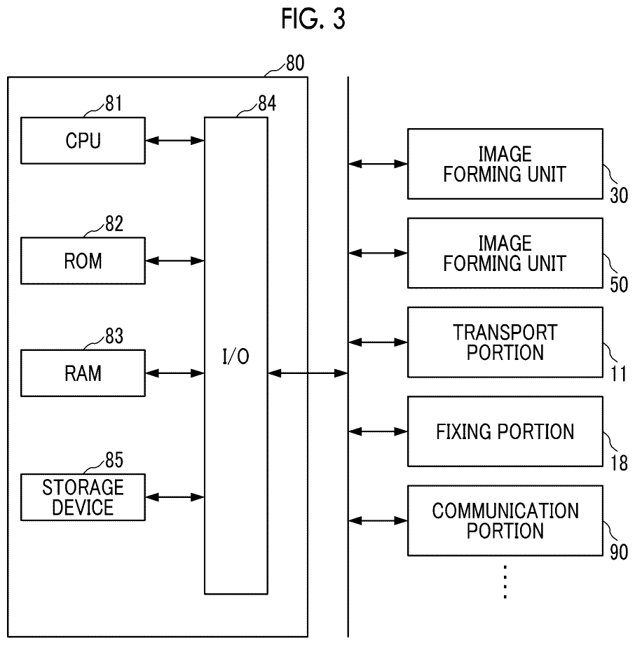

Next, the control device 80 that controls an operation of the image forming apparatus 10 will be described using FIG. 3.

As illustrated in FIG. 3, the image forming unit 30, the image forming unit 50, the transport portion 11, a communication portion 90, and the like are electrically connected to the control device 80.

As illustrated in FIG. 3, the control device 80 includes a central processing unit (CPU) 81, a read only memory (ROM) 82, a random access memory (RAM) 83, a storage device 85 such as a hard disk drive, and an input/output interface (abbreviated to I/O) 84 that inputs and outputs data to and from each device and the like via a network. These constituents are connected to each other via a control bus.

The ROM 82 stores an image forming control program, not illustrated, to be executed by the CPU 81. The CPU 81 executes printing processing based on the image forming control program, not illustrated, by reading out the image forming control program, not illustrated, from the ROM 82 and loading the image forming control program into the RAM 83. While the present exemplary embodiment describes the CPU 81 as reading out and executing the image forming control program stored in the ROM 82, the present disclosure is not limited to this. The image forming control program may be provided in the form of a recording on a computer-readable recording medium. For example, the image forming control program may be provided in the form of a recording on an optical disc such as a compact disc (CD)-ROM and a digital versatile disc (DVD)-ROM or in the form of a recording on a semiconductor memory such as a universal serial bus (USB) memory and a memory card. The image forming control program may be acquired from an external device via a communication line connected to the input/output interface 84. The image forming control program may be provided as, for example, standalone application software or may be incorporated into software of each device as one function of the image forming apparatus 10.

The image forming unit 30, the image forming unit 50, the transport portion 11, the communication portion 90, and the like are connected to the I/O 84. The communication portion 90 is an interface for performing data communication between a terminal apparatus such as a personal computer and the image forming apparatus 10.

The control device 80 performs various controls for forming the toner images on the intermediate transfer belt 40 via the image forming portions 32 of each color of the image forming unit 30. Similarly, the control device 80 performs various controls for forming the toner images on the intermediate transfer belt 60 via the image forming portions 52 of each color of the image forming unit 50.

The control device 80 controls each of the developing biases applied to the developing rolls 39 and 59 of the developing devices 36 and 56. The control device 80 controls each of the transfer biases applied to the secondary transfer rolls 24 and 25.

The control device 80 controls a supply timing, a supply time, a supply amount, and the like of toner supply for toner of each color from a toner cartridge of each color to the developing devices 36 and 56.

### Speed Variation Point

Next, a speed variation point during transport of the sheet in the image forming apparatus 10 will be described.

In the image forming apparatus 10 of the present exemplary embodiment described above, the toner images are formed on the sheet PP using the two image forming units 30 and 50. In each image forming unit of the two image forming units 30 and 50, the toner images formed by the plurality of image forming portions 32 and 52 are primarily transferred onto the intermediate transfer belts 40 and 60, respectively, and the toner images on the intermediate transfer belts 40 and 60 are secondarily transferred onto the sheet PP transported along the transport path 19. That is, in forming the toner images on the sheet PP using two image forming units 30 and 50, the secondary transfer is performed at two secondary transfer positions TJ2 and TK2. Thus, the sheet PP fed from the sheet storage portion 12 such as a sheet feed tray passes through the two secondary transfer positions TJ2 and TK2 via the sheet feed rolls 14 and the resist rolls 15.

However, in a case where a sheet rear end passes through the sheet feed rolls 14 or the resist rolls 15 in forming the images on the sheet PP using such a configuration, a sheet transport speed may partially change while the images are being formed on one sheet PP. In a case where the sheet transport speed partially changes, partial misregistration occurs between the respective images formed by two image forming units 30 and 50 on one sheet.

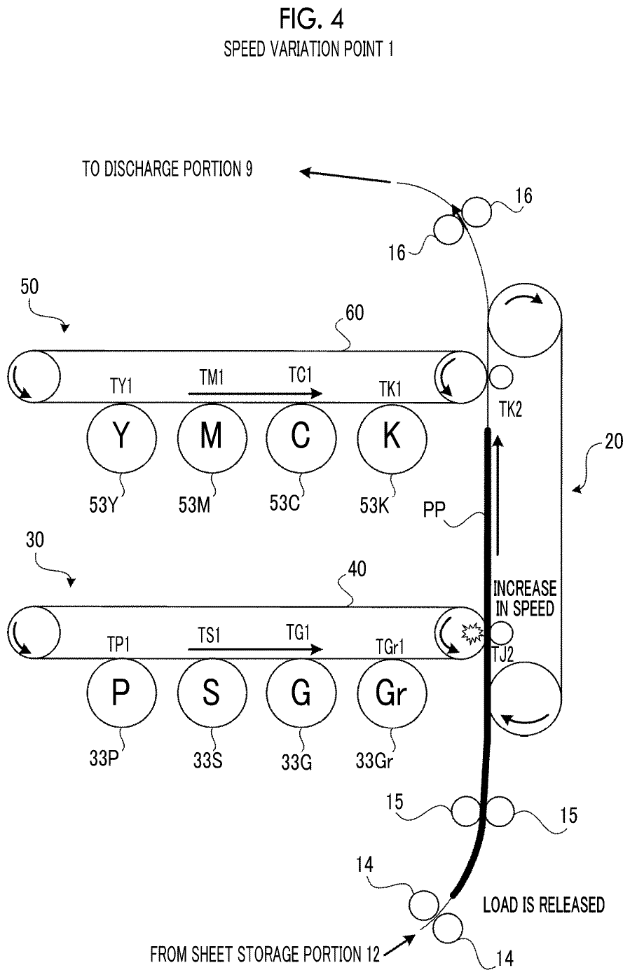

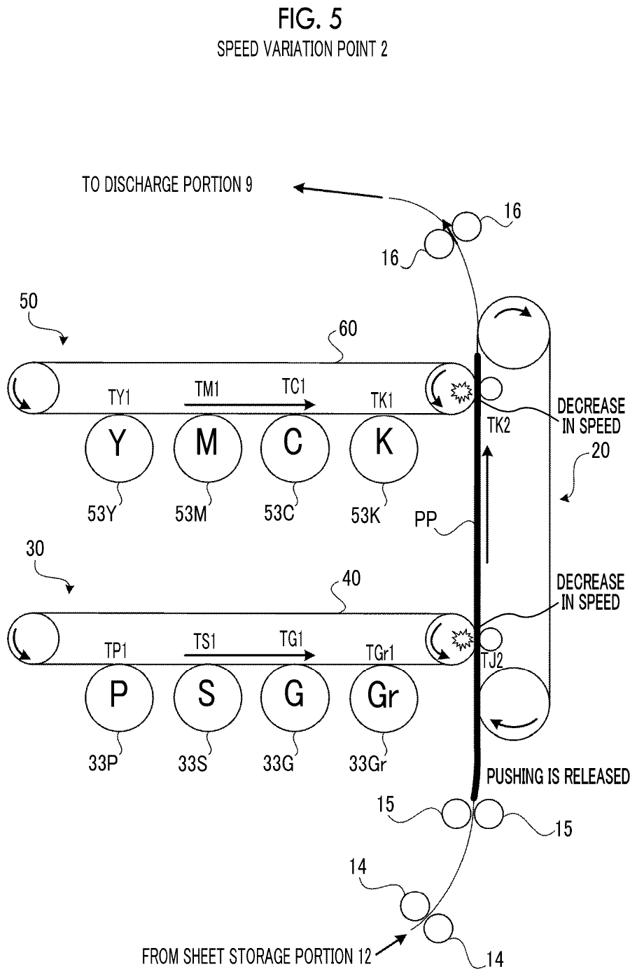

Two speed variation points that occur during sheet transport will be described with reference to FIGS. 4 and 5.

FIG. 4 is a diagram illustrating speed variation point 1 that is one of the two speed variation points. Specifically, FIG. 4 is a diagram illustrating a state immediately after a rear end of the sheet PP passes through the sheet feed rolls 14. What is understood with reference to FIG. 4 is that the transport speed of the sheet PP at the secondary transfer position TJ2 is increased by release of a transport load after the rear end of the sheet PP passes through the sheet feed rolls 14.

FIG. 5 is a diagram illustrating speed variation point 2 that is the other of the two speed variation points. Specifically, FIG. 5 is a diagram illustrating a state immediately after the rear end of the sheet PP passes through the resist rolls 15. What is understood with reference to FIG. 5 is that the transport speed of the sheet PP at the secondary transfer positions TJ2 and TK2 is decreased by release from pushing of the resist rolls 15 after the rear end of the sheet PP passes through the resist rolls 15.

In forming the images on one sheet PP in the above manner, the sheet transport speed may vary each time the rear end of the sheet PP passes through the sheet feed rolls 14 or the resist rolls 15. Thus, even in a case where misregistration on the intermediate transfer belts 40 and 60 is completely eliminated by adjusting misregistration of an image forming position between the respective image forming portions 32 and 52 of two image forming units 30 and 50, misregistration occurs at an image position formed on the sheet PP because of variation in the transport speed of the sheet PP at the secondary transfer position TJ2.

Therefore, in the image forming apparatus 10 of the present exemplary embodiment, partial misregistration between respective images formed by two image forming units 30 and 50 on one sheet PP is suppressed using a method described below.

In performing registration between a position of the image printed on the sheet PP by the image forming unit 30 and a position of the image printed on the sheet PP by the image forming unit 50, the CPU 81 that is a processor causes each of one image forming portion 32 selected from four image forming portions 32 of the image forming unit 30 and one image forming portion 52 selected from four image forming portions 52 of the image forming unit 50 to form the image at the same position on the sheet PP. The CPU 81 reduces a misregistration amount by partially changing a drawing cycle of the image in any one of the image forming unit 30 or the image forming unit 50 in accordance with a relative misregistration amount between the two formed images.

Specifically, the CPU 81 causes each of one image forming portion 32 selected from four image forming portions 32 of the image forming unit 30 and one image forming portion 52 selected from four image forming portions 52 of the image forming unit 50 to form a test pattern image consisting of a plurality of straight lines at intervals set in advance at the same position on the sheet PP. The CPU 81 detects a start point and an end point of a speed change in the sheet transport speed from the misregistration amount between each of the formed straight lines. The CPU 81 reduces the misregistration amount by partially changing the drawing cycle of the image between the detected start point and the detected end point.

More specifically, a straight line image formed by the selected image forming portion 32 or the selected image forming portion 52 in any one image forming unit of the image forming unit 30 or the image forming unit 50 is used as a reference position. In a case where a position of a straight line image formed by the selected image forming portion 32 or 52 in the other image forming unit deviates to a rear side of the sheet transport direction, the CPU 81 reduces the misregistration amount by partially reducing the drawing cycle of the image in the other image forming unit. In a case where the position of the straight line image formed by the selected image forming portion 32 or 52 in the other image forming unit deviates to a front side of the sheet transport direction, the CPU 81 reduces the misregistration amount by partially extending the drawing cycle of the image in the other image forming unit.

Misregistration correction of an absolute position of each of the image forming unit 30 and the image forming unit 50 may be performed instead of performing relative misregistration correction between the image forming unit 30 and the image forming unit 50 as described above.

In this case, the CPU 81 causes each of one image forming portion 32 selected from four image forming portions 32 of the image forming unit 30 and one image forming portion 52 selected from four image forming portions 52 of the image forming unit 50 to form the image on a reference position of a reference sheet provided with an absolute reference position in advance. The CPU 81 reduces the misregistration amount by partially changing the drawing cycle of the image in each of the image forming unit 30 and the image forming unit 50 in accordance with the misregistration amount between the two formed images and the reference position.

Specifically, a sheet provided with a plurality of reference lines at intervals set in advance is used as the sheet provided with the absolute reference position in advance. The CPU 81 detects the start point and the end point of the speed change in the sheet transport speed from the misregistration amount between the straight line image formed by each of the selected image forming portion 32 and the selected image forming portion 52 in the image forming unit 30 and the image forming unit 50 and the reference line using positions of the reference lines as the reference position. The CPU 81 reduces the misregistration amount of each of the image forming unit 30 and the image forming unit 50 by partially changing the drawing cycle of the image between the detected start point and the detected end point.

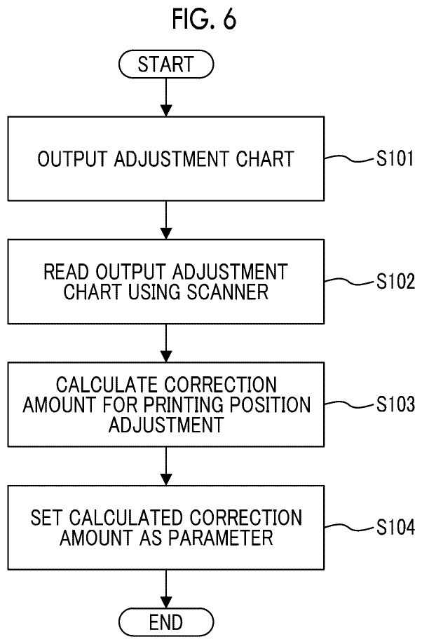

An overall operation in performing the misregistration correction between two image forming units 30 and 50 described above will be described with reference to the flowchart in FIG. 6.

First, in step S101, the CPU 81 outputs an adjustment chart using one image forming portion 32 and one image forming portion 52 selected from the image forming unit 30 and the image forming unit 50, respectively.

In step S102, the output adjustment chart is read using a scanner or the like provided in an apparatus other than the image forming apparatus 10 of the present exemplary embodiment.

Then, in step S103, the CPU 81 calculates a correction amount for printing position adjustment based on a read image of the adjustment chart. In step S104, the CPU 81 performs the misregistration correction by setting the calculated correction amount as a parameter for printing.

Processing of step S103 in the overall operation described above may be performed outside the image forming apparatus 10 instead of being performed in the CPU 81, and only the obtained correction amount may be fed back to the image forming apparatus 10.

Next, an operation of the misregistration correction described above will be described in detail using a specific image example.

### Misregistration Correction Based on Absolute Position

First, the misregistration correction based on the absolute position out of the misregistration correction based on the relative position described above and the misregistration correction based on the absolute position will be described.

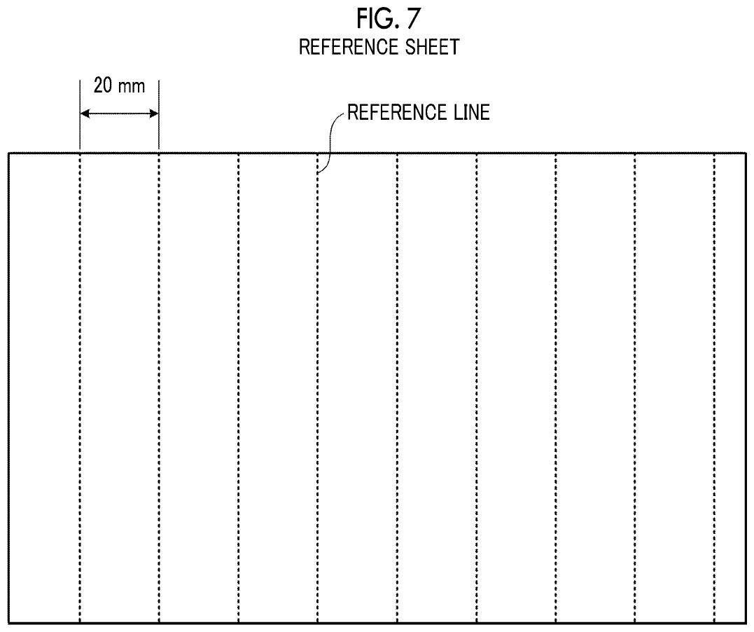

The misregistration correction based on the absolute position uses a reference sheet as illustrated in FIG. 7. FIG. 7 illustrates an example of a reference sheet on which a plurality of reference lines orthogonal to the transport direction of the sheet are printed at intervals of 20 mm in advance.

In the following description, the image forming portion 32Gr is selected as a reference image forming portion among four image forming portions 32P, 32S, 32G, and 32Gr on a side corresponding to the image forming unit 30. In the following description, the image forming portion 52K is selected as a reference image forming portion among four image forming portions 52Y, 52M, 52C, and 52K on a side corresponding to the image forming unit 50. That is, a case of selecting the color Gr as a reference color on the side corresponding to the image forming unit 30 and selecting the color K as a reference color on the side corresponding to the image forming unit 50 will be described.

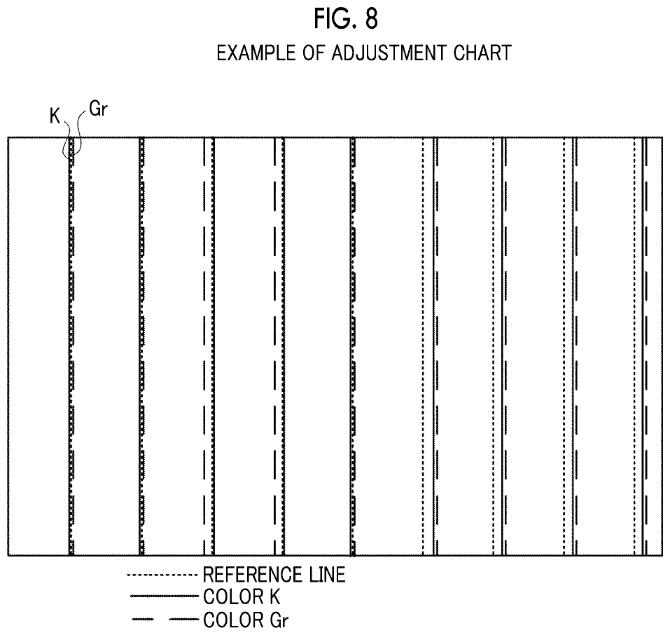

In performing misregistration adjustment based on such a setting, the CPU 81 generates the adjustment chart by printing straight lines at intervals of 20 mm using the color K and the color Gr in correspondence with positions of the reference lines on the reference sheet illustrated in FIG. 7. FIG. 8 illustrates an example of the adjustment chart generated in such a manner. In FIG. 8, straight lines of the color K are indicated by solid lines, and straight lines of the color Gr are indicated by broken lines. The reference lines are indicated by dotted lines for distinction on the drawing. In a case where two straight lines overlap with each other, recognition of the two straight lines on the drawing is difficult. Thus, even in a case where two straight lines overlap with each other, a small interval will be intentionally provided therebetween.

In a case where the sheet transport speed is constant and there is no misregistration on the transport path 19 to which the sheet PP fed from the sheet storage portion 12 is discharged by the discharge rolls 17, the straight lines of the color K and the straight lines of the color Gr are printed on the reference lines.

However, what is understood with reference to the adjustment chart illustrated in FIG. 8 is that misregistration from a correct printing position occurs because each of the straight lines of the color K and the straight lines of the color Gr deviate from the reference lines. What is also understood is that the misregistration amount of the misregistration partially changes in one sheet.

Therefore, the CPU 81 detects a speed change point of the transport speed of the sheet from the misregistration amount of the straight lines of the color K and the color Gr with respect to the reference lines from image data obtained by reading the adjustment chart using the scanner. The CPU 81 calculates the correction amount for correcting the misregistration based on the detected speed change point.

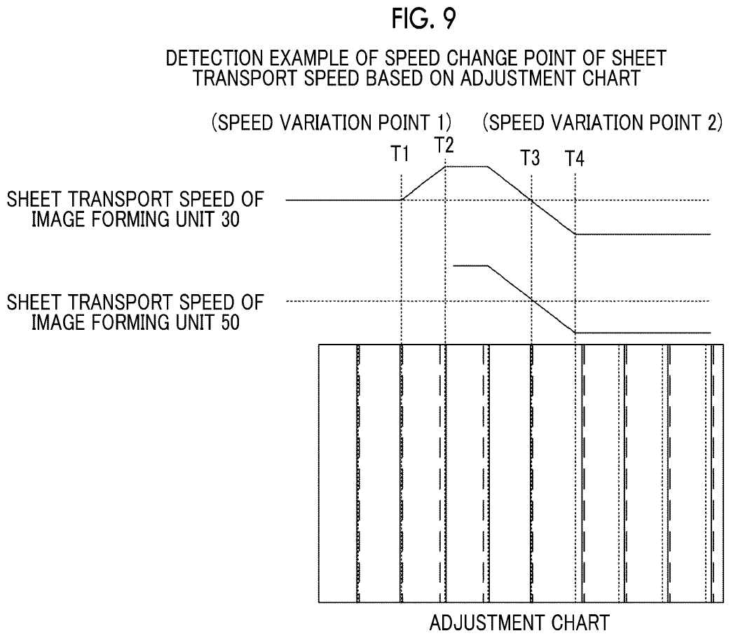

FIG. 9 illustrates a detection example in a case where the speed change point of the sheet transport speed is detected from the adjustment chart illustrated in FIG. 8 in the above manner.

What is understood with reference to FIG. 9 is that, in the image forming unit 30, misregistration starts because the sheet transport speed is increased at time T1 because of an effect of speed variation point 1 illustrated in FIG. 4, and the sheet transport speed is constant in an increased state at time T2. In performing the misregistration correction based on such a detection example, the CPU 81 changes the drawing cycle of the image in the image forming unit 30 at time T1 and fixes the changed drawing cycle of the image at time T2.

What is understood with reference to FIG. 9 is that, in the image forming unit 30, the misregistration is decreased along with the sheet transport speed starting to decrease at time T3 because of an effect of speed variation point 2 illustrated in FIG. 5, and the sheet transport speed is constant in a decreased state at time T4. In performing the misregistration correction based on such a detection example, the CPU 81 changes the drawing cycles of the images in the image forming units 30 and 50 at time T3 and fixes the changed drawing cycles of the images at time T4.

### Misregistration Correction Based on Relative Position

In performing the misregistration correction based on the absolute position described above, the reference sheet as illustrated in FIG. 7 needs to be prepared in advance. Thus, in a case where the reference sheet cannot be prepared, the misregistration correction cannot be performed. Therefore, the misregistration correction based on the relative position is performed as a method of performing the misregistration adjustment without using the reference sheet.

Next, such misregistration correction based on the relative position will be described.

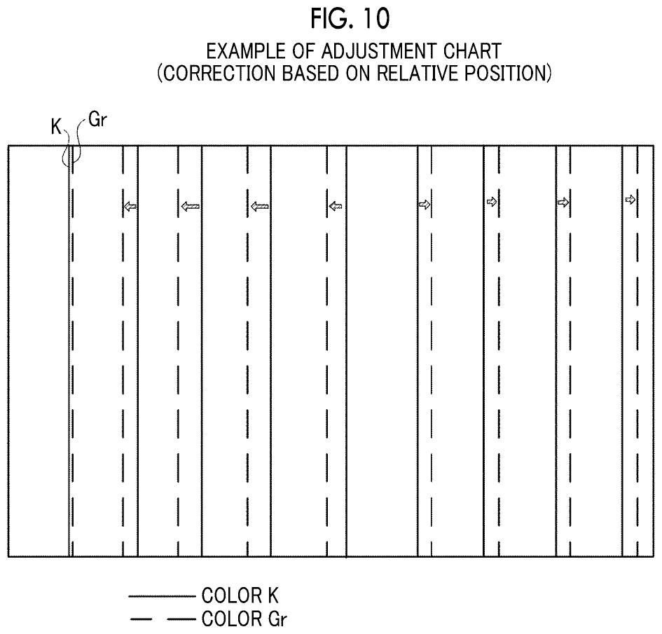

In performing such misregistration adjustment based on the relative position, the CPU 81 generates an adjustment chart by printing straight lines at intervals of 20 mm using the color K and the color Gr on a general printing sheet. FIG. 10 illustrates an example of the adjustment chart generated in such a manner. In FIG. 10, straight lines of the color K are indicated by solid lines, and straight lines of the color Gr are indicated by broken lines, as described above.

In a case where the sheet transport speed is constant and there is no misregistration on the transport path 19 to which the sheet PP fed from the sheet storage portion 12 is discharged by the discharge rolls 17, the straight lines of the color K and the straight lines of the color Gr are printed as overlapping with each other.

However, what is understood with reference to the adjustment chart illustrated in FIG. 10 is that printing positions of the image forming unit 30 and the image forming unit 50 deviate from each other because the straight lines of the color K and the straight lines of the color Gr are printed in a deviating manner from each other.

Therefore, the CPU 81 detects the speed change point of the transport speed of the sheet by reading the relative misregistration amount between the straight lines of the color K and the color Gr from image data obtained by reading the adjustment chart using the scanner. The CPU 81 calculates the correction amount for correcting the misregistration based on the detected speed change point. A case of performing the misregistration correction to align the printing position of the image of the color Gr of the image forming unit 30 with the printing position of the color K using the color K in the image forming unit 50 as the reference color will be described.

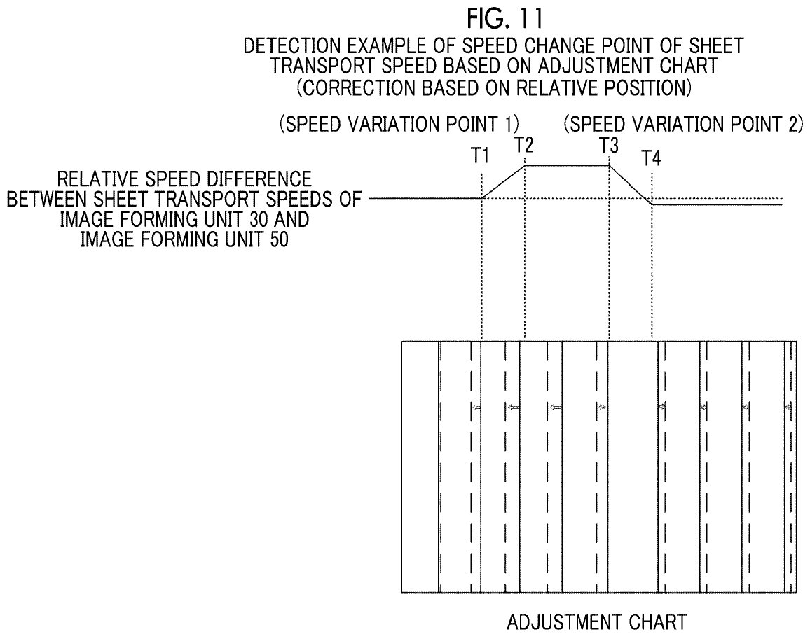

FIG. 11 illustrates a detection example in a case where the speed change point of the sheet transport speed is detected from the adjustment chart illustrated in FIG. 10 in the above manner.

What is understood with reference to FIG. 11 is that misregistration starts because a speed difference in a relative sheet transport speed between the image forming unit 30 and the image forming unit 50 starts to increase at time T1 because of the effect of speed variation point 1 illustrated in FIG. 4, and the speed difference is constant at time T2. In performing the misregistration correction based on such a detection example, the CPU 81 changes the drawing cycle of the image in the image forming unit 30 at time T1 and fixes the changed drawing cycle of the image at time T2.

What is understood with reference to FIG. 11 is that the speed difference in the relative sheet transport speed between the image forming unit 30 and the image forming unit 50 starts to decrease at time T3 because of the effect of speed variation point 2 illustrated in FIG. 5, and the speed difference is constant in a decreased state at time T4. In performing the misregistration correction based on such a detection example, the CPU 81 changes the drawing cycle of the image in the image forming unit 30 at time T3 and fixes the changed drawing cycle of the image at time T4.

Partially changing the drawing cycle of the image causes the printed image to partially expand or contract or enlarge on one sheet.

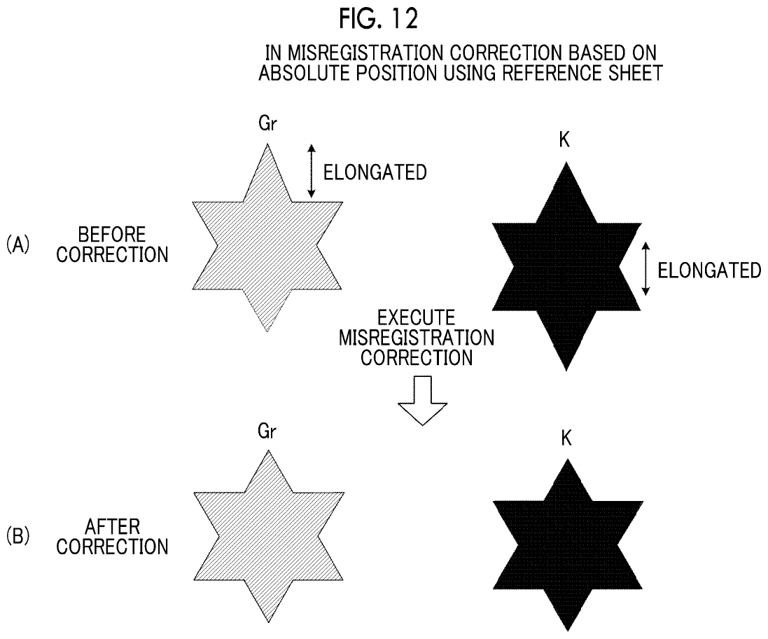

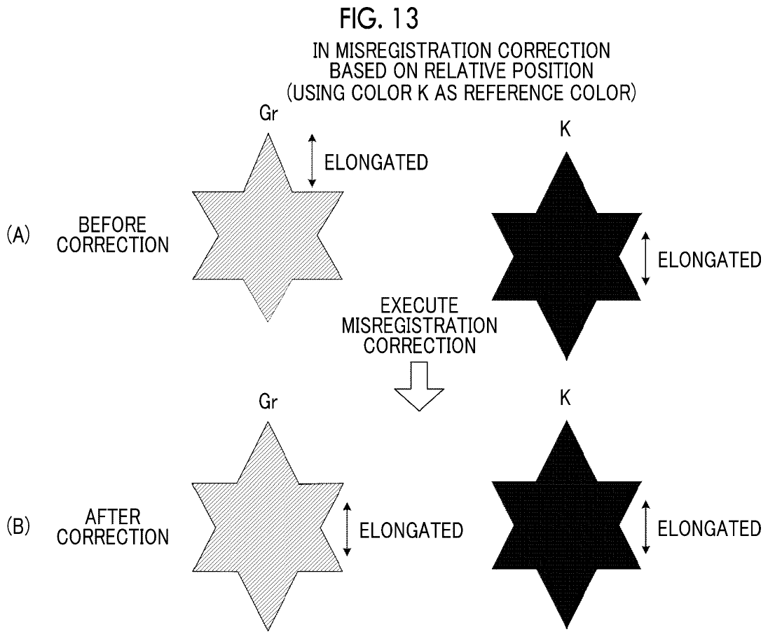

Thus, how the printing position of the image after correction is corrected by performing the misregistration correction as described above will be described with reference to FIGS. 12 and 13.

FIG. 12 is a diagram illustrating a state of the printed image in a case where the misregistration correction is performed based on the absolute position using the reference sheet. FIG. 13 is a diagram illustrating a state of the printed image in a case where the misregistration correction is performed based on the relative position.

Both of a part (A) in FIG. 12 and a part (A) FIG. 13 illustrate an image example before performing the misregistration correction. What is understood with reference to the part (A) in FIG. 12 and the part (A) in FIG. 13 is that a star-shaped image of the color Gr has an elongated shape of an upper portion with respect to a normal shape in the image before performing the misregistration correction. What is also understood is that the star-shaped image has an elongated shape of a center part with respect to a normal shape in the image of the color K.

A part (B) in FIG. 12 illustrates an image example after correction in a case where the misregistration correction based on the absolute position is performed in a state where such misregistration occurs. What is understood with reference to the part (B) in FIG. 12 is that both of the image of the color Gr and the image of the color K are changed to images having normal shapes by performing the misregistration correction based on the absolute position using the reference sheet.

Meanwhile, a part (B) in FIG. 13 illustrates an image example after correction in a case where the misregistration correction based on the relative position is performed. What is understood with reference to the part (B) in FIG. 13 is that correction that aligns the image of the color Gr with the image of the color K is made by performing the misregistration correction based on the relative position. Specifically, what is understood is that the shape of the upper portion in the star-shaped image of the color Gr is corrected to the normal shape like the star-shaped image of the color K, but the normal shape of the center part in the star-shaped image of the color Gr is changed to an elongated shape with respect to the normal shape because of the alignment with the image of the color K.

However, with any correction method of the misregistration correction based on the absolute position or the misregistration correction based on the relative position, the misregistration between the image of the color Gr and the image of the color K is suppressed, and the misregistration between the image printed by the image forming unit 30 and the image printed by the image forming unit 50 on the sheet is suppressed.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The term “system” in the present exemplary embodiment includes both of a system configured with a plurality of apparatuses and a system configured with a single apparatus.

The present disclosure can also be applied to a program and a program product.

### Supplementary Note

(((1))) An image forming system comprising:
a first image forming unit including a plurality of first image forming portions and a first intermediate transfer medium to which a toner image formed by the plurality of first image forming portions is primarily transferred;
a second image forming unit that is provided on a downstream side of a sheet transport direction with respect to the first image forming unit and that includes a plurality of second image forming portions and a second intermediate transfer medium to which a toner image formed by the plurality of second image forming portions is primarily transferred;
a sheet transport portion that transports a sheet to a secondary transfer position at which each of the toner image formed on the first intermediate transfer medium of the first image forming unit and the toner image formed on the second intermediate transfer medium of the second image forming unit is secondarily transferred; and
a processor configured to:
   in performing registration between a position of an image printed on the sheet by the first image forming unit and a position of an image printed on the sheet by the second image forming unit, cause each of one first image forming portion selected from the plurality of first image forming portions of the first image forming unit and one second image forming portion selected from the plurality of second image forming portions of the second image forming unit to form the image at the same position on the sheet, and reduce a misregistration amount by partially changing a drawing cycle of the image in any one of the first image forming unit or the second image forming unit in accordance with a relative misregistration amount between the two formed images.

(((2))) The image forming system according to (((1))), wherein the processor is configured to:
cause each of one first image forming portion selected from the plurality of first image forming portions of the first image forming unit and one second image forming portion selected from the plurality of second image forming portions of the second image forming unit to form a test pattern image consisting of a plurality of straight lines at intervals set in advance at the same position on the sheet, and reduce a misregistration amount by detecting a start point and an end point of a speed change of a sheet transport speed from the misregistration amount between each of the formed straight lines and partially changing the drawing cycle of the image between the detected start point and the detected end point.

(((3))) The image forming system according to (((2))), wherein the processor is configured to:
using a straight line image formed by the selected image forming portion in any one image forming unit of the first image forming unit or the second image forming unit as a reference position, reduce a misregistration amount by partially reducing the drawing cycle of the image in the other image forming unit in a case where a position of a straight line image formed by the selected image forming portion in the other image forming unit deviates to a rear side in the sheet transport direction, and partially extending the drawing cycle of the image in the other image forming unit in a case where the position deviates to a front side in the sheet transport direction.

(((4))) The image forming system according to (((1))), wherein the processor is configured to:
cause each of one first image forming portion selected from the plurality of first image forming portions of the first image forming unit and one second image forming portion selected from the plurality of second image forming portions of the second image forming unit to form the image on a reference position of the sheet provided with an absolute reference position in advance, and reduce a misregistration amount by partially changing the drawing cycle of the image in each of the first image forming unit and the second image forming unit in accordance with the misregistration amount between the two formed images and the reference position.

(((5))) The image forming system according to (((4))),
wherein the sheet provided with the absolute reference position in advance is a sheet provided with a plurality of reference lines at intervals set in advance, and
the processor is configured to:
   using positions of the reference lines as a reference position, reduce a misregistration amount of each of the first image forming unit and the second image forming unit by detecting a start point and an end point of a speed change of a sheet transport speed from the misregistration amount between a straight line image formed by each selected image forming portion in the first image forming unit and the second image forming unit and the reference lines and partially changing the drawing cycle of the image between the detected start point and the detected end point.

(((6))) A program causing a computer to execute a process comprising:
in an image forming apparatus including a first image forming unit including a plurality of first image forming portions and a first intermediate transfer medium to which a toner image formed by the plurality of first image forming portions is primarily transferred, a second image forming unit that is provided on a downstream side of a sheet transport direction with respect to the first image forming unit and that includes a plurality of second image forming portions and a second intermediate transfer medium to which a toner image formed by the plurality of second image forming portions is primarily transferred, and a sheet transport portion that transports a sheet to a secondary transfer position at which each of the toner image formed on the first intermediate transfer medium of the first image forming unit and the toner image formed on the second intermediate transfer medium of the second image forming unit is secondarily transferred,
causing, in performing registration between a position of an image printed on the sheet by the first image forming unit and a position of an image printed on the sheet by the second image forming unit, each of one first image forming portion selected from the plurality of first image forming portions of the first image forming unit and one second image forming portion selected from the plurality of second image forming portions of the second image forming unit to form the image at the same position on the sheet; and
reducing a misregistration amount by partially changing a drawing cycle of the image in any one of the first image forming unit or the second image forming unit in accordance with a relative misregistration amount between the two formed images.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
a first image forming unit including a plurality of first image forming portions and a first intermediate transfer medium to which a toner image formed by the plurality of first image forming portions is primarily transferred;
a second image forming unit that is provided on a downstream side of a sheet transport direction with respect to the first image forming unit and that includes a plurality of second image forming portions and a second intermediate transfer medium to which a toner image formed by the plurality of second image forming portions is primarily transferred;
a sheet transport portion that transports a sheet to a secondary transfer position at which each of the toner image formed on the first intermediate transfer medium of the first image forming unit and the toner image formed on the second intermediate transfer medium of the second image forming unit is secondarily transferred; and
a processor configured to:
in performing registration between a position of an image printed on the sheet by the first image forming unit and a position of an image printed on the sheet by the second image forming unit, cause each of one first image forming portion selected from the plurality of first image forming portions of the first image forming unit and one second image forming portion selected from the plurality of second image forming portions of the second image forming unit to form the image at the same position on the sheet, and reduce a misregistration amount by partially changing a drawing cycle of the image in any one of the first image forming unit or the second image forming unit in accordance with a relative misregistration amount between the two formed images.

2. The image forming system according to claim 1, wherein the processor is configured to:
cause each of one first image forming portion selected from the plurality of first image forming portions of the first image forming unit and one second image forming portion selected from the plurality of second image forming portions of the second image forming unit to form a test pattern image consisting of a plurality of straight lines at intervals set in advance at the same position on the sheet, and reduce a misregistration amount by detecting a start point and an end point of a speed change of a sheet transport speed from the misregistration amount between each of the formed straight lines and partially changing the drawing cycle of the image between the detected start point and the detected end point.

3. The image forming system according to claim 2, wherein the processor is configured to:
using a straight line image formed by the selected image forming portion in any one image forming unit of the first image forming unit or the second image forming unit as a reference position, reduce a misregistration amount by partially reducing the drawing cycle of the image in the other image forming unit in a case where a position of a straight line image formed by the selected image forming portion in the other image forming unit deviates to a rear side in the sheet transport direction, and partially extending the drawing cycle of the image in the other image forming unit in a case where the position deviates to a front side in the sheet transport direction.

4. The image forming system according to claim 1, wherein the processor is configured to:
cause each of one first image forming portion selected from the plurality of first image forming portions of the first image forming unit and one second image forming portion selected from the plurality of second image forming portions of the second image forming unit to form the image on a reference position of the sheet provided with an absolute reference position in advance, and reduce a misregistration amount by partially changing the drawing cycle of the image in each of the first image forming unit and the second image forming unit in accordance with the misregistration amount between the two formed images and the reference position.

5. The image forming system according to claim 4,
wherein the sheet provided with the absolute reference position in advance is a sheet provided with a plurality of reference lines at intervals set in advance, and
the processor is configured to:
using positions of the reference lines as a reference position, reduce a misregistration amount of each of the first image forming unit and the second image forming unit by detecting a start point and an end point of a speed change of a sheet transport speed from the misregistration amount between a straight line image formed by each selected image forming portion in the first image forming unit and the second image forming unit and the reference lines and partially changing the drawing cycle of the image between the detected start point and the detected end point.

6. A non-transitory computer readable medium storing a program causing a computer to execute a process comprising:
in an image forming apparatus including a first image forming unit including a plurality of first image forming portions and a first intermediate transfer medium to which a toner image formed by the plurality of first image forming portions is primarily transferred, a second image forming unit that is provided on a downstream side of a sheet transport direction with respect to the first image forming unit and that includes a plurality of second image forming portions and a second intermediate transfer medium to which a toner image formed by the plurality of second image forming portions is primarily transferred, and a sheet transport portion that transports a sheet to a secondary transfer position at which each of the toner image formed on the first intermediate transfer medium of the first image forming unit and the toner image formed on the second intermediate transfer medium of the second image forming unit is secondarily transferred,
causing, in performing registration between a position of an image printed on the sheet by the first image forming unit and a position of an image printed on the sheet by the second image forming unit, each of one first image forming portion selected from the plurality of first image forming portions of the first image forming unit and one second image forming portion selected from the plurality of second image forming portions of the second image forming unit to form the image at the same position on the sheet; and
reducing a misregistration amount by partially changing a drawing cycle of the image in any one of the first image forming unit or the second image forming unit in accordance with a relative misregistration amount between the two formed images.

7. An image forming method comprising:
in an image forming apparatus including a first image forming unit including a plurality of first image forming portions and a first intermediate transfer medium to which a toner image formed by the plurality of first image forming portions is primarily transferred, a second image forming unit that is provided on a downstream side of a sheet transport direction with respect to the first image forming unit and that includes a plurality of second image forming portions and a second intermediate transfer medium to which a toner image formed by the plurality of second image forming portions is primarily transferred, and a sheet transport portion that transports a sheet to a secondary transfer position at which each of the toner image formed on the first intermediate transfer medium of the first image forming unit and the toner image formed on the second intermediate transfer medium of the second image forming unit is secondarily transferred,
causing, in performing registration between a position of an image printed on the sheet by the first image forming unit and a position of an image printed on the sheet by the second image forming unit, each of one first image forming portion selected from the plurality of first image forming portions of the first image forming unit and one second image forming portion selected from the plurality of second image forming portions of the second image forming unit to form the image at the same position on the sheet; and
reducing a misregistration amount by partially changing a drawing cycle of the image in any one of the first image forming unit or the second image forming unit in accordance with a relative misregistration amount between the two formed images.
